(19) United States
(12) Patent Application Publication
(10) Pub. No.: US 2025/0199538 A1
(43) Pub. Date: Jun. 19, 2025

(54) ROBOT AND METHOD FOR CONTROLLING THE SAME

(71) Applicants: HYUNDAI MOTOR COMPANY, Seoul (KR); KIA CORPORATION, Seoul (KR)

(72) Inventors: Jae Hyuk Choi, Hwaseong-si (KR); Jun Hwan Park, Hwaseong-si (KR); Hun Keon Ko, Hwaseong-si (KR); Ho Seong Kang, Hwaseong-si (KR); Ji Woo Ha, Hwaseong-si (KR); Ye Sol Kim, Hwaseong-si (KR); Joo Young Chun, Hwaseong-si (KR); Geun Sang Yu, Hwaseong-si (KR)

(73) Assignees: HYUNDAI MOTOR COMPANY, Seoul (KR); KIA CORPORATION, Seoul (KR)

(21) Appl. No.: 18/825,789

(22) Filed: Sep. 5, 2024

(30) Foreign Application Priority Data
Dec. 13, 2023 (KR) 10-2023-0181270

(51) Int. Cl. G05D 1/49; G05D 1/65; G05D 1/656; G05D 105/20

(52) U.S. Cl. CPC G05D 1/498; G05D 1/65; G05D 1/656; G05D 2105/20

(57) ABSTRACT

A robot includes a moving body including a body part, an information acquisition part, and a controller that controls the moving body. The moving body further includes a plurality of wheels disposed on both sides of the body part in a front-rear direction. The controller determines a first allowable acceleration that is an allowable acceleration of the moving body in a reference posture and a second allowable acceleration that is an allowable acceleration of the moving body in a current posture, compares the first allowable acceleration and the second allowable acceleration, and controls the moving body based on the posture of the moving body and a difference between the first allowable acceleration and the second allowable acceleration.

### CROSS-REFERENCE TO RELATED APPLICATION

This application claims the benefit of and priority to Korean Patent Application No. 10-2023-0181270, filed on Dec. 13, 2023, the entire contents of which are incorporated herein by reference.

### TECHNICAL FIELD

The present disclosure relates to a robot and a method of controlling the same.

### BACKGROUND

A mobile robot may move an object to a target position. For example, an object that is required to be delivered may be loaded on the mobile robot, and the mobile robot may deliver the loaded object to the target position. As the center of mass of a system including the loaded object loaded on the mobile robot and the mobile robot becomes higher, a risk of the loaded object turning over together with the mobile robot may become greater.

The mobile robot according to the related art is driven with relatively low traveling performance compared to an implementable traveling performance to decrease the risk of the mobile robot turning over together with the loaded object. When the mobile robot is driven with low traveling performance, a delivery speed of the loaded object decreases, and the decrease in the delivery speed causes a decrease in the demand of the mobile robot.

The statements in this Background section merely provide background information related to the present disclosure and may not constitute prior art.

### SUMMARY

The present disclosure has been made to solve the above-mentioned problems occurring in the prior art while advantages achieved by the prior art are maintained intact.

An aspect of the present disclosure provides a robot that may increases a delivery speed of a loaded object, and at the same time, may reduce a risk of turning over with the loaded object.

The technical problems to be solved by the present disclosure are not limited to the aforementioned problems, and any other technical problems not mentioned herein should be clearly understood from the following description by those having ordinary skill in the art to which the present disclosure pertains.

According to an aspect of the present disclosure, a robot includes a moving body including a body part on which an object is loaded and traveling on a ground, an information acquisition part that acquires information on a system including a loaded object that is the object loaded on the body part and the moving body, and a controller that controls the moving body based on the information acquired by the information acquisition part. The moving body further includes a plurality of wheels, each of which is provided to be rotatable about each corresponding reference rotation axis of a plurality of reference rotation axes. The body part is connected to the plurality of wheels to be movable in a circumferential direction of each of the plurality of wheels and is spaced apart from each of the plurality of reference rotation axes in a radial direction of each of the plurality of wheels. The radial direction of each of the plurality of wheels is perpendicular to each corresponding reference rotation axis of the plurality of reference rotation axes. The plurality of wheels is disposed on (e.g., is arranged on) both sides of the body part in a front-rear direction. When a posture of the moving body in a state in which a separation distance between the plurality of wheels disposed on both sides of the body part in the front-rear direction is greatest is referred to as a reference posture, the controller determines a first allowable acceleration and a second allowable acceleration based on information on a weight of the system and information on a position of a center of mass of the system. The first allowable acceleration is an allowable acceleration of the moving body in the reference posture, and the second allowable acceleration is an allowable acceleration of the moving body in a current posture. The controller also compares the first allowable acceleration and the second allowable acceleration that are determined, allows the moving body to travel in the reference posture when a difference between the first allowable acceleration and the second allowable acceleration is greater than or equal to a predetermined threshold value, and controls the posture of the moving body such that the moving body travels in the current posture when the difference between the first allowable acceleration and the second allowable acceleration is smaller than the predetermined threshold value.

Further, the controller may control the moving body such that an acceleration of the moving body in the reference posture is smaller than or equal to the first allowable acceleration when the difference between the first allowable acceleration and the second allowable acceleration is greater than or equal to the predetermined threshold value, and may control the moving body such that an acceleration of the moving body in the current posture is smaller than or equal to the second allowable acceleration when the difference between the first allowable acceleration and the second allowable acceleration is smaller than the predetermined threshold value.

Further, a first direction and a second direction may be parallel to the front-rear direction and opposite to each other, and when the moving body is accelerated in the first direction, and an area in contact with the ground on a wheel, among the plurality of wheels, disposed in the body part in the second direction is referred to as a ground area, the controller may determine the first allowable acceleration and the second allowable acceleration based on a separation distance between the ground area and the center of mass of the system.

Further, when a ground contacting area of the moving body in the reference posture is referred to as a first ground area, the system including the moving body and the loaded object in the reference posture is referred to as a first system, a separation distance between the first ground area and a center of mass of the first system in a horizontal direction is referred to as horizontal separation distance of the first system, and a separation distance between the first ground area and the center of mass of the first system in a vertical direction is referred to as a vertical separation distance of the first system, the first allowable acceleration may be a value obtained by dividing a product of the horizontal separation distance of the first system and a gravitational acceleration by the vertical separation distance of the first system. When a ground contacting area of the moving body in the current posture is referred to as a second ground area, the system including the moving body and the loaded object in the current posture is referred to as a second system, a separation distance between the second ground area and a center of mass of the second system in the horizontal direction is referred to as a horizontal separation distance of the second system, and a separation distance between the second ground area and the center of mass of the second system in the vertical direction is referred to as a vertical separation distance of the second system, the second allowable acceleration may be defined as a value obtained by dividing a product of the horizontal separation distance of the second system and the gravitational acceleration by the vertical separation distance of the second system.

Further, the first allowable acceleration may correspond to a first ratio of a maximum acceleration at which the system including the moving body and the loaded object in the reference posture is not turned over in the front-rear direction, and the first ratio may be 100% or less. The second allowable acceleration may correspond to a second ratio of a maximum acceleration at which the system including the moving body and the loaded object in the current posture is not turned over in the front-rear direction, and the second ratio may 100% or less.

According to another aspect of the present disclosure, a method of controlling a robot is provided. The robot includes a moving body including a body part and a plurality of wheels disposed on (e.g., arranged on) both sides of the body part in a front-rear direction and traveling on a ground. The method includes determining a first allowable acceleration and a second allowable acceleration based on information on a weight of a system including a loaded object that is an object loaded on the body part and the moving body and information on a center of mass of the system. The first allowable acceleration is an allowable acceleration of the moving body in a reference posture and that the second allowable acceleration is an allowable acceleration of the moving body in a current posture. The method also includes comparing the first allowable acceleration and the second allowable acceleration. The method further includes controlling a traveling posture of the moving body, based on a comparison result of the first allowable acceleration and the second allowable acceleration, such that the moving body travels in the reference posture when a difference between the first allowable acceleration and the second allowable acceleration is greater than or equal to a predetermined threshold value, and the moving body travels in the current posture when the difference between the first allowable acceleration and the second allowable acceleration is smaller than the predetermined threshold value. The reference posture is a posture of the moving body in a state in which a separation distance between the plurality of wheels disposed on (e.g., arranged on) both sides of the body part in the front-rear direction is greatest.

Further, the method may further include controlling the moving body such that an acceleration of the moving body in the reference posture is smaller than or equal to the first allowable acceleration when the difference between the first allowable acceleration and the second allowable acceleration is greater than or equal to the predetermined threshold value and controlling the moving body such that an acceleration of the moving body in the current posture is smaller than or equal to the second allowable acceleration when the difference between the first allowable acceleration and the second allowable acceleration is smaller than the predetermined threshold value.

Further, a first direction and a second direction may be parallel to the front-rear direction and opposite to each other. When the moving body is accelerated in the first direction, and an area in contact with the ground on a wheel, among the plurality of wheels, disposed in the body part in the second direction is referred to as a ground area, in determining the first allowable acceleration and the second allowable acceleration, the first allowable acceleration and the second allowable acceleration may be determined based on a separation distance between the ground area and the center of mass of the system.

Further, in determining the first allowable acceleration and the second allowable acceleration, when a ground contacting area of the moving body in the reference posture is referred to as a first ground area, the system including the moving body and the loaded object in the reference posture is referred to as a first system, a separation distance between the first ground area and a center of mass of the first system in a horizontal direction is referred to as a horizontal separation distance of the first system, and a separation distance between the first ground area and the center of mass of the first system in a vertical direction is referred to as a vertical separation distance of the first system, the first allowable acceleration may be calculated by dividing a product of the horizontal separation distance of the first system and a gravitational acceleration by the vertical separation distance of the first system. When a ground contacting area of the moving body in the current posture is referred to as a second ground area, the system including the moving body and the loaded object in the current posture is referred to as a second system, a separation distance between the second ground area and a center of mass of the second system in the horizontal direction is referred to as a horizontal separation distance of the second system, and a separation distance between the second ground area and the center of mass of the second system in the vertical direction is referred to as a vertical separation distance of the second system, the second allowable acceleration may be calculated by dividing a product of the horizontal separation distance of the second system and the gravitational acceleration by the vertical separation distance of the second system.

Further, the first allowable acceleration may correspond to a first ratio of a maximum acceleration at which the system including the moving body and the loaded object in the reference posture is not turned over in the front-rear direction, and the first ratio may be 100% or less. The second allowable acceleration may correspond to a second ratio of a maximum acceleration at which the system including the moving body and the loaded object in the current posture is not turned over in the front-rear direction, and the second ratio may be 100% or less.

### BRIEF DESCRIPTION OF THE DRAWINGS

The above and other objects, features and advantages of the present disclosure are more apparent from the following detailed description taken in conjunction with the accompanying drawings:

FIG. 1 is a block diagram of a robot according to an embodiment of the present disclosure;

FIG. 2 is a perspective view of a moving body according to the embodiment of the present disclosure;

FIG. 3 is a view illustrating a state in which a loaded object is seated on the moving body according to the embodiment of the present disclosure;

FIG. 4 is a view illustrating a state in which the moving body is seated in a current posture that deviates from a reference posture according to the embodiment of the present disclosure;

FIG. 5 is a view illustrating a state in which the moving body is seated on the reference posture according to the embodiment of the present disclosure; and

FIG. 6 is a schematic flowchart illustrating a method of controlling the robot according to the embodiment of the present disclosure.

The drawings described herein are for illustration purposes only and are not intended to limit the scope of the present disclosure in any way.

### DETAILED DESCRIPTION

Hereinafter, some embodiments of the present disclosure are described in detail with reference to the drawings. In adding reference numerals to components of each drawing, it should be noted that identical or equivalent components are designated by an identical numeral even when they are displayed on other drawings. Further, in describing the embodiment of the present disclosure, a detailed description of the related known configuration or function has been omitted when it is determined that it interferes with the understanding of the embodiment of the present disclosure.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function.

Hereinafter, a robot 1 according to an embodiment of the present disclosure is described with reference to the accompanying drawings.

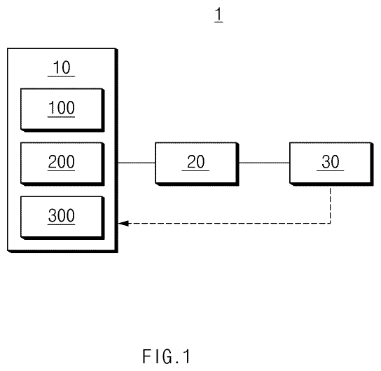

FIG. 1 is a block diagram of a robot according to an embodiment of the present disclosure.

Referring to FIG. 1, the robot 1 may deliver an object that is required to be delivered to a target position. The robot 1 may be named a “delivery robot” or a “mobile robot.” The robot 1 may include a moving body 10, an information acquisition part 20, and a controller 30.

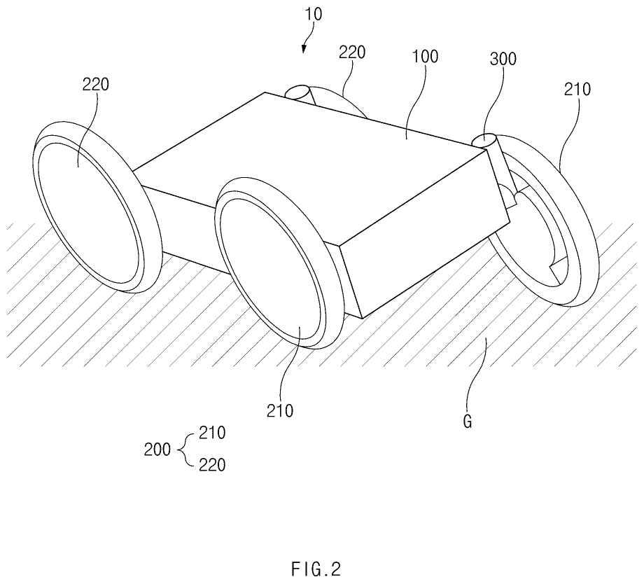

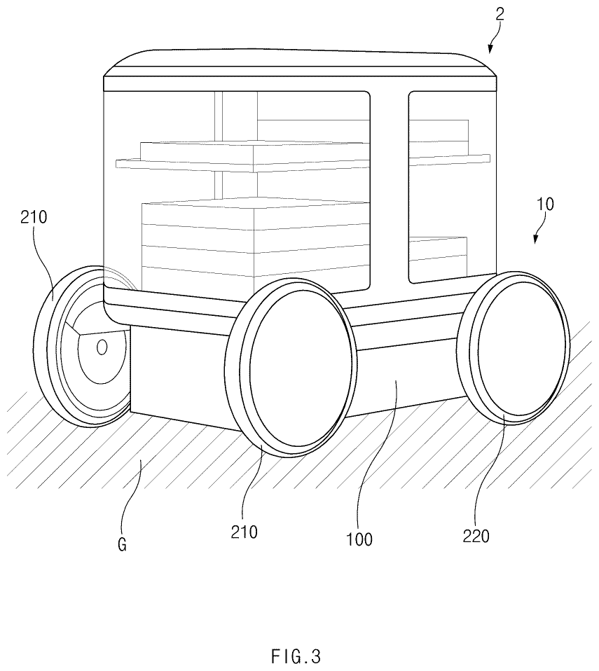

FIG. 2 is a perspective view of a moving body according to the embodiment of the present disclosure, and FIG. 3 is a view illustrating a state in which a loaded object is seated on the moving body according to the embodiment of the present disclosure.

Referring further to FIGS. 2 and 3, the moving body 10 may travel on a ground surface “G.” The moving body 10 may deliver a loaded object 2 to the target position. The loaded object 2 may mean an object loaded on a body part 100 of the moving body 10, which is described below. The moving body 10 may include the body part 100, a wheel 200, and a driving part 300.

The loaded object 2 may be seated on the body part 100. The body part 100 may be supported on the wheel 200. The body part 100 may be spaced upward from the ground surface “G.”

The wheel 200 may rotate about a reference rotation axis. The reference rotation axis may be defined as an imaginary straight line that passes through a center of the wheel 200 and extends in a direction in which the wheel 200 and the body part 100 are connected to each other. The wheel 200 may rotate about an eccentric rotation axis with respect to the body part 100. The eccentric rotation axis may be defined as an imaginary straight line that is spaced apart from the reference rotation axis and is parallel to the reference rotation axis. In other words, when the wheel 200 rotates with respect to the body part 100, the reference rotation axis may revolve with respect to the eccentric rotation axis. The wheel 200 may rotate about the reference rotation axis and revolve about the eccentric rotation axis.

For example, when the wheel 200 rotates with respect to the body part 100 so that the reference rotation axis is positioned above the eccentric rotation axis, a height of the body part 100 with respect to the ground surface “G” may increase. Further, when the wheel 200 rotates with respect to the body part 100 so that the reference rotation axis is positioned below the eccentric rotation axis, a height of the body part 100 with respect to the ground surface “G” may increase.

The wheel 200 may be provided as a plurality of wheels 200. The plurality of wheels 200 may rotate with respect to the body part 100 independently of each other. For example, the plurality of wheels 200 may rotate with respect to the body part 100 independently of each other such that heights of the reference rotation axes of two or more wheels among the plurality of wheels 200 are different from or the same as each other.

The plurality of wheels 200 may include a front wheel 210 and a rear wheel 220. The front wheel 210 may be connected to a front side of the body part 100. As an example, the front wheel 210 may be provided as two front wheels 210. One front wheel of the two front wheels 210 may be connected to a left side of the front side of the body part 100, and the other one front wheel thereof may be connected to a right side of the front side of the body part 100. The front wheel connected to the left side of the front side of the body part 100 may be named a first front wheel, and the front wheel connected to the right side of the front side of the body part 100 may be named a second front wheel.

The reference rotation axis of the first front wheel may be named a first front reference rotation axis, and the eccentric rotation axis of the first front wheel may be named a first front eccentric rotation axis. The reference rotation axis of the second front wheel may be named a second front reference rotation axis, and the eccentric rotation axis of the second front wheel may be named a second front eccentric rotation axis.

The rear wheel 220 may be connected to a rear side of the body part 100. As an example, the rear wheel 220 may be provided as two rear wheels 220. One rear wheel of the two rear wheels 220 may be connected to a left side of the rear side of the body part 100, and the other one rear wheel thereof may be connected to a right side of the rear side of the body part 100. The rear wheel connected to the left side of the rear side of the body part 100 may be named a first rear wheel, and the rear wheel connected to the right side of the rear side of the body part 100 may be named a second rear wheel.

The reference rotation axis of the first rear wheel may be named a first rear reference rotation axis, and the eccentric rotation axis of the first rear wheel may be named a first rear eccentric rotation axis. The reference rotation axis of the second rear wheel may be named a second rear reference rotation axis, and the eccentric rotation axis of the second rear wheel may be named a second rear eccentric rotation axis.

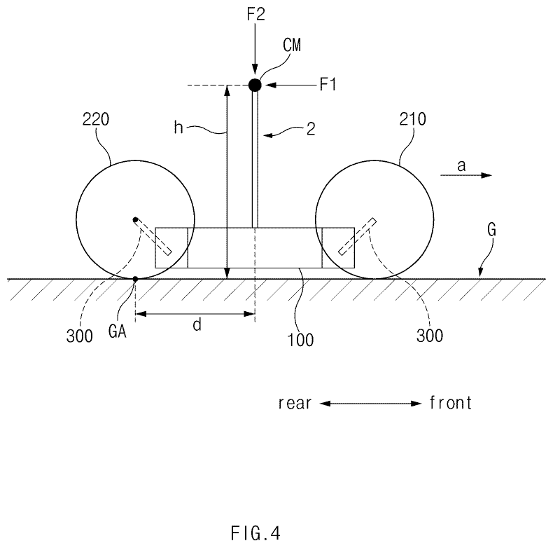

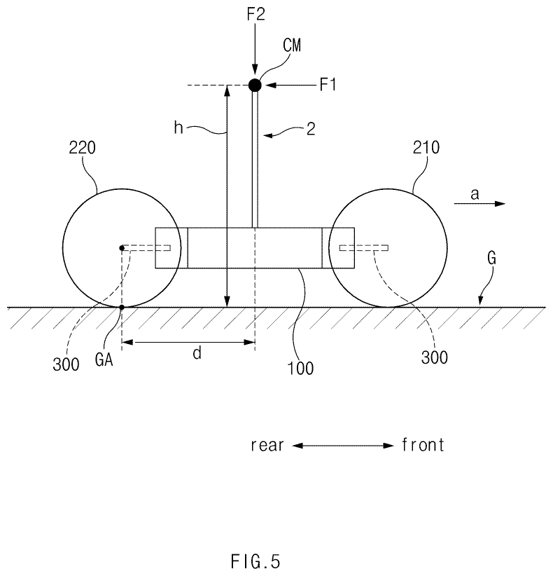

FIG. 4 is a view illustrating a state in which the moving body is seated in a current posture that deviates from a reference posture according to the embodiment of the present disclosure, and FIG. 5 is a view illustrating a state in which the moving body is seated on the reference posture according to the embodiment of the present disclosure.

Referring further to FIGS. 4 and 5, the driving part 300 may provide a driving force to the wheel 200. For example, the driving part 300 may provide the driving force to the wheel 200 so that the wheel 200 rotates about the reference rotation axis. Further, the driving part 300 may rotate the wheel 200 with respect to the body part 100 so that the reference rotation axis revolves with respect to the eccentric rotation axis. The driving part 300 may include a link, a revolution motor, and a rotation motor.

The link may connect the body part 100 and the wheel 200. The link may space the reference rotation axis and the eccentric rotation axis apart from each other. The link may be oriented in a direction that intersects the reference rotation axis (or the eccentric rotation axis). One end of the link may be connected to the wheel 200 to be rotatable about the reference rotation axis, and the other end of the link may be connected to the body part 100 to be rotatable about the eccentric rotation axis. For example, the reference rotation axis may pass through the one end of the link, and the eccentric rotation axis may pass through the other end of the link.

The revolution motor may be disposed at one end of the link. The revolution motor may rotate the link with respect to the body part 100 about the eccentric rotation axis.

The rotation motor may be disposed at the other end of the link. The rotation motor may rotate the wheel 200 with respect to the link about the reference rotation axis.

The driving part 300 may be provided as a plurality of driving parts 300. The plurality of driving parts 300 may include a first front driver that connects the first front wheel and the body part 100, a second front driver that connects the second front wheel and the body part 100, a first rear driver that connects the first rear wheel and the body part 100, and a second rear driver that connects the second rear wheel and the body part 100.

The information acquisition part 20 may acquire information on a system including the loaded object 2 and the moving body 10. The information on the system may include weight information that is information on a weight of the system and position information that is information on a position of a center CM of mass of the system.

The weight of the system may be defined as a product of the mass of the system and acceleration of gravity. Further, the position information may include horizontal position information that is information on a horizontal separation distance “d” that is a separation distance between a ground area GA of the wheel 200 and the center CM of mass of the system in a horizontal direction.

The ground area GA may mean an area of the wheel 200, which is grounded to the ground surface “G.” For example, when a wheel disposed on a side of the body part 100 in a second direction (opposite to a first direction) is referred to as a reference wheel based on a state in which the moving body 10 is accelerated in the first direction (e.g., a direction corresponding to a direction vector parallel to a front-rear direction among acceleration direction vectors of the moving body 10), the ground area GA may mean an area of the reference wheel, which is grounded with the ground surface “G.” As a detailed example, when the moving body 10 is accelerated in a direction toward the left side of the front side, the reference wheel may be the rear wheel 220, and the ground area GA may be an area of the rear wheel 220, which is grounded with the ground surface “G.”

Further, the position information may further include vertical position information that is information on a vertical separation distance “h” that is a separation distance between the center CM of mass of the system and the ground surface “G” (e.g., the ground area GA) in a vertical direction.

As an example, the information acquisition part 20 may acquire information on the system through information on the loaded object 2 that is input from an external unit (e.g., a user or the like) and information on the moving body 10 that is input in advance.

As another example, the information acquisition part 20 may acquire the information on the system through the information on the loaded object 2 which are acquired through movement of the moving body 10 on which the loaded object 2 is seated and the information on the moving body 10 that is input in advance.

The controller 30 may control the moving body 10 based on the information acquired by the information acquisition part 20. For example, the controller 30 may determine an allowable acceleration of the moving body 10 based on the weight information and the position information. The allowable acceleration may correspond to a certain ratio of a maximum acceleration at which the system is not turned over in the front-rear direction. As an example, the certain ratio may be 100% or less. The fact that the system is not turned over in the front-rear direction means that the system does not rotate about the ground area GA forward or rearward. For example, when an acceleration “a” with respect to the ground surface “G” of the system is greater than the allowable acceleration when the certain ratio of 100%, the system may be turned over in the front-rear direction. In other words, when the acceleration “a” of the system with respect to the ground surface “G” is smaller than or equal to the allowable acceleration when the certain ratio is 100%, the system may not be turned over in the front-rear direction.

For example, when an inertial force applied to the system in a second direction (e.g., a rearward direction) due to the acceleration “a” of the system toward the first direction (e.g., a forward direction) is referred to as a first force F1, when a gravitational force applied to the system downward is referred to as a second force F2, and when a first torque (a product of the first force F1 and the vertical separation distance “h”) that is a torque applied to the ground area GA by the first force F1 is smaller or equal to a second torque (a product of the second force F2 and the horizontal separation distance “d”) that is a torque applied to the ground area GA by the second force F2, the system may not be turned over in the front-rear direction. In other words, when a direction vector of a net torque applied to the ground area GA is parallel to a direction vector of the first torque, the system may be turned over, and when the direction vector of the net torque is parallel to a direction vector of the second torque, the system may not be turned over.

In other words, as the vertical separation distance “h” increases (the first torque increases), as the acceleration “a” increases (the first torque increases), and as a separation distance between the front wheel 210 and the rear wheel 220 decreases (the second torque decreases), the possibility that the system is turned over may increase.

Referring back to FIGS. 4 and 5, the controller 30 may determine a first allowable acceleration that is an allowable acceleration of the moving body 10 (see FIG. 5) in a reference posture and a second allowable acceleration that is an allowable acceleration of the moving body 10 (see FIG. 4) in a current posture based on the weight information and the position information. The reference posture may be named an “eccentric ground parallel posture,” and the current posture may be named an “eccentric general posture.”

The reference posture may be defined as a posture of the moving body 10 in a state in which the separation distance between the front wheel 210 and the rear wheel 220 is the greatest. The current posture may mean a current posture of the moving body 10. The current posture may be understood as a concept that includes the same posture as the reference posture and a posture of the moving body 10 that deviates from the reference posture. A height of a center of the body part 100 of the moving body 10 in the current posture may be the same as a height of the center of the body part 100 of the moving body 10 in the reference posture or may be smaller than a height of the body part 100 of the moving body 10 in the reference posture. For example, when the current posture that is not the reference posture is switched to the reference posture, a height of the center of mass of the system may decrease, and a separation distance between the front wheel 210 and the rear wheel 220 of the moving body 10 may decrease.

The first allowable acceleration may correspond to a first certain ratio of the maximum acceleration at which a system (a first system) including the moving body 10 and the loaded object 2 in the reference posture is not turned over in the front-rear direction. The first certain ratio may be 100% or less. For example, the first certain ratio may be in a range of 70% to 100%, but the present disclosure is not limited to this example. In other words, when acceleration of the first system is smaller than or equal to the first allowable acceleration, the first system may not be turned over.

The first allowable acceleration may be defined as a value obtained by dividing a product of the gravitational acceleration and the horizontal separation distance “d” between a first ground area that is the ground area GA of the moving body 10 and the first system in the reference posture by the vertical separation distance “h” between the first ground area and the first system.

The second allowable acceleration may correspond to a second certain ratio of the maximum acceleration at which a system (a second system) including the moving body 10 and the loaded object 2 in the current posture is not turned over in the front-rear direction. The second certain ratio may be 100% or less. For example, the second certain ratio may be in a range of 70% to 100%, but the present disclosure is not limited to this example. In other words, when acceleration of the second system is smaller than or equal to the second allowable acceleration, the second system may not be turned over.

The second allowable acceleration may be defined as a value obtained by dividing a product of the gravitational acceleration and the horizontal separation distance “d” between a second ground area that is the ground area GA of the moving body 10 and the second system in the current posture by the vertical separation distance “h” between the second ground area and the second system.

The second allowable acceleration may be smaller than or equal to the first allowable acceleration. For example, the moving body 10 in the reference posture may be the moving body 10 when traveling performance of the moving body 10 is maximized. In other words, when the moving body 10 in the current posture is in a posture that deviates from the reference posture, the moving body in the current posture may have low traveling performance as compared to the reference posture.

The controller 30 may compare the determined first allowable acceleration and the determined second allowable acceleration. For example, when a difference between the first allowable acceleration and the second allowable acceleration is greater than or equal to a predetermined threshold value, the controller 30 may control the posture of the moving body 10 so that the moving body 10 travels in the reference posture.

As an example, the threshold value may be zero. However, the threshold value is not limited to zero, and an absolute value of a real number close to zero enough to exhibit the same or similar effect as that when the threshold value is zero may be set as the threshold value.

Further, when the difference between the first allowable acceleration and the second allowable acceleration is greater than or equal to the threshold value, the controller 30 may control the moving body 10 so that the acceleration of the moving body 10 is smaller than the first allowable acceleration.

Further, when the difference between the first allowable acceleration and the second allowable acceleration is smaller than the threshold value, the controller 30 may control the posture of the moving body 10 so that the moving body 10 travels while maintaining the current posture.

Further, when the difference between the first allowable acceleration and the second allowable acceleration is smaller than the threshold value, the controller 30 may control the moving body so that the acceleration of the moving body 10 is smaller than or equal to the second allowable acceleration.

In the robot 1, the posture and the acceleration of the moving body 10 are controlled to cope with various situations based on the weight of the system including the loaded object 2 and the moving body 10 and a relative position of the center of mass of the system, and thus the moving body 10 on which the loaded object 2 is seated may be prevented from being turned over, and at the same time, optimal traveling performance may be achieved.

The controller 30 may be electrically connected to the information acquisition part 20 and the moving body 10 and may be implemented as a process having a function of decoding and executing commands based on input information.

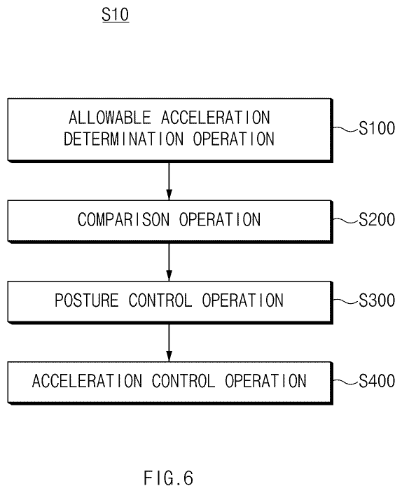

Hereinafter, a method S10 of controlling a robot according to the embodiment of the present disclosure is described with reference to FIG. 6.

FIG. 6 is a schematic flowchart illustrating a method of controlling the robot according to the embodiment of the present disclosure.

The method S10 of controlling a robot may include an allowable acceleration determination operation S100, a comparison operation S200, a posture control operation S300, and an acceleration control operation S400.

In the allowable acceleration determination operation S100, the loaded object 2 may be loaded on the body part 100 of the moving body 10. In the allowable acceleration determination operation S100, the weight information and the position information may be acquired.

Further, in the allowable acceleration determination operation S100, the first allowable acceleration and the second allowable acceleration may be determined based on the weight information and the position information of the system, which are acquired. For example, in the allowable acceleration determination operation S100, the first allowable acceleration and the second allowable acceleration may be determined based on a separation distance between the ground area GA and the center of mass of the system. The allowable acceleration determination operation S100 may include a first allowable acceleration calculation operation and a second allowable acceleration calculation operation.

In the first allowable acceleration calculation operation, the first allowable acceleration may be calculated by dividing a product of the horizontal separation distance “d” of the first system and the gravitational acceleration by the vertical separation distance “h” of the first system.

In the second allowable acceleration calculation operation, the second allowable acceleration may be calculated by dividing a product of the horizontal separation distance “d” of the second system and the gravitational acceleration by the vertical separation distance “h” of the second system.

In the comparison operation S200, the first allowable acceleration and the second allowable acceleration may be compared. For example, in the comparison operation S200, a magnitude of the first allowable acceleration and a magnitude of the second allowable acceleration may be compared.

In the posture control operation S300, a traveling posture of the moving body 10 may be controlled based on the comparison result between the first allowable acceleration and the second allowable acceleration in the comparison operation S200. For example, in the posture control operation S300, when the difference between the first allowable acceleration and the second allowable acceleration is greater than or equal to the threshold value, the posture of the moving body 10 may be controlled so that the moving body 10 travels in the reference posture.

Further, in the posture control operation S300, when the difference between the first allowable acceleration and the second allowable acceleration is smaller than the threshold value, the posture of the moving body 10 may be controlled so that the moving body 10 travels in the current posture. In other words, in the posture control operation S300, when the difference between the first allowable acceleration and the second allowable acceleration is smaller than the threshold value, the posture of the moving body may be controlled so that the moving body 10 is maintained in the current posture.

In the acceleration control operation S400, the acceleration of the moving body 10 may be controlled based on the comparison result between the first allowable acceleration and the second allowable acceleration. For example, in the acceleration control operation S400, when the difference between the first allowable acceleration and the second allowable acceleration is greater than or equal to the threshold value, the acceleration of the moving body 10 may be controlled so that the acceleration of the moving body 10 in the reference posture is smaller than or equal to the first allowable acceleration.

Further, in the acceleration control operation S400, when the difference between the first allowable acceleration and the second allowable acceleration is smaller than the threshold value, the acceleration of the moving body 10 may be controlled so that the acceleration of the moving body 10 in the current posture is smaller than or equal to the second allowable acceleration.

In a robot according to the present disclosure, a delivery speed of a loaded object increases, and at the same time, a risk of turning over together with the loaded object decreases.

Hereinabove, even though it has been described that all components constituting the embodiments of the present disclosure are combined into one part or are operated while combined with each other, the present disclosure is not necessarily limited to these embodiments. In other words, all the components may be operated while selectively combined into one or more parts within the scope of the present disclosure. Further, terms such as “includes”, “constitutes”, or “have” described above mean that the corresponding component may be inherent unless otherwise stated, and thus should be construed as not excluding other components but further including other components. All terms including technical or scientific terms have the same meanings as those commonly understood by those having ordinary skill in the art to which the present disclosure pertains unless otherwise defined. The generally used terms defined in the dictionaries should be construed as having the meanings that coincide with the meanings of the contexts of the related technologies, and should not be construed as ideal or excessively formal meanings unless clearly defined in the present disclosure.

The above description is merely illustrative of the technical spirit of the present disclosure, and those having ordinary skill in the art to which the present disclosure belongs may make various modifications and changes without departing from the essential features of the present disclosure. Thus, the embodiments disclosed in the present disclosure are not intended to limit the technology spirit of the present disclosure, but are intended to describe the present disclosure, and the scope of the technical spirit of the present disclosure is not limited by these embodiments. The scope of protection of the present disclosure should be interpreted by the appended claims, and all technical spirits within the scope equivalent thereto should be interpreted as being included in the scope of the present disclosure.

What is claimed is:

1. A robot comprising:
a moving body including a body part on which an object is loaded and traveling on a ground;
an information acquisition part configured to acquire information on a system, wherein the system includes the moving body and a loaded object loaded on the body part; and
a controller configured to control the moving body based on the information acquired by the information acquisition part,
wherein the moving body further includes a plurality of wheels, each of the plurality of wheels being rotatable about each corresponding reference rotation axis of a plurality of reference rotation axes,
wherein the body part is connected to the plurality of wheels to be movable in a circumferential direction of each of the plurality of wheels and is spaced apart from each of the plurality of reference rotation axes in a radial direction of each of the plurality of wheels, wherein the radial direction of each of the plurality of wheels is perpendicular to each corresponding reference rotation axis of the plurality of reference rotation axes,
wherein the plurality of wheels is disposed on both sides of the body part in a front-rear direction, and
wherein, when a posture of the moving body in a state in which a separation distance between the plurality of wheels disposed on both sides of the body part in the front-rear direction is greatest is referred to as a reference posture, the controller is configured to:
determine a first allowable acceleration and a second allowable acceleration based on information on a weight of the system and information on a position of a center of mass of the system, wherein the first allowable acceleration is an allowable acceleration of the moving body in the reference posture, and the second allowable acceleration is an allowable acceleration of the moving body in a current posture;
compare the first allowable acceleration and the second allowable acceleration;
allow the moving body to travel in the reference posture when a difference between the first allowable acceleration and the second allowable acceleration is greater than or equal to a predetermined threshold value; and
control the posture of the moving body such that the moving body travels in the current posture when the difference between the first allowable acceleration and the second allowable acceleration is smaller than the predetermined threshold value.

2. The robot of claim 1, wherein the controller is configured to:
control the moving body such that an acceleration of the moving body in the reference posture is smaller than or equal to the first allowable acceleration when the difference between the first allowable acceleration and the second allowable acceleration is greater than or equal to the predetermined threshold value; and
control the moving body such that an acceleration of the moving body in the current posture is smaller than or equal to the second allowable acceleration when the difference between the first allowable acceleration and the second allowable acceleration is smaller than the predetermined threshold value.

3. The robot of claim 1, wherein a first direction and a second direction are parallel to the front-rear direction and opposite to each other, and
wherein, when the moving body is accelerated in the first direction, and an area in contact with the ground on a wheel, among the plurality of wheels, disposed in the body part in the second direction is referred to as a ground area,
the controller is configured to determine the first allowable acceleration and the second allowable acceleration based on a separation distance between the ground area and the center of mass of the system.

4. The robot of claim 3, wherein, when a ground contacting area of the moving body in the reference posture is referred to as a first ground area, the system including the moving body and the loaded object in the reference posture is referred to as a first system, a separation distance between the first ground area and a center of mass of the first system in a horizontal direction is referred to as a horizontal separation distance of the first system, and a separation distance between the first ground area and the center of mass of the first system in a vertical direction is referred to as a vertical separation distance of the first system,
the first allowable acceleration is a value obtained by dividing a product of the horizontal separation distance of the first system and a gravitational acceleration by the vertical separation distance of the first system, and
wherein, when a ground contacting area of the moving body in the current posture is referred to as a second ground area, the system including the moving body and the loaded object in the current posture is referred to as a second system, a separation distance between the second ground area and a center of mass of the second system in the horizontal direction is referred to as a horizontal separation distance of the second system, and a separation distance between the second ground area and the center of mass of the second system in the vertical direction is referred to as a vertical separation distance of the second system,
the second allowable acceleration is a value obtained by dividing a product of the horizontal separation distance of the second system and the gravitational acceleration by the vertical separation distance of the second system.

5. The robot of claim 1, wherein the first allowable acceleration corresponds to a first ratio of a maximum acceleration at which the system including the moving body and the loaded object in the reference posture is not turned over in the front-rear direction, and the first ratio is 100% or less, and
wherein the second allowable acceleration corresponds to a second ratio of a maximum acceleration at which the system including the moving body and the loaded object in the current posture is not turned over in the front-rear direction, and the second ratio is 100% or less.

6. A method of controlling a robot including a moving body, the moving body including a body part and a plurality of wheels disposed on both sides of the body part in a front-rear direction and traveling on a ground,
the method comprising:
determining a first allowable acceleration and a second allowable acceleration based on information on a weight of a system including the moving body and a loaded object loaded on the body part and information on a center of mass of the system, wherein the first allowable acceleration is an allowable acceleration of the moving body in a reference posture, and the second allowable acceleration is an allowable acceleration of the moving body in a current posture;
comparing the first allowable acceleration and the second allowable acceleration; and
controlling a traveling posture of the moving body, based on a comparison result of the first allowable acceleration and the second allowable acceleration, such that the moving body travels in the reference posture when a difference between the first allowable acceleration and the second allowable acceleration is greater than or equal to a predetermined threshold value, and the moving body travels in the current posture when the difference between the first allowable acceleration and the second allowable acceleration is smaller than the predetermined threshold value, and
wherein the reference posture is a posture of the moving body in a state in which a separation distance between the plurality of wheels disposed on both sides of the body part in the front-rear direction is greatest.

7. The method of claim 6, further comprising:
controlling the moving body such that an acceleration of the moving body in the reference posture is smaller than or equal to the first allowable acceleration when the difference between the first allowable acceleration and the second allowable acceleration is greater than or equal to the predetermined threshold value; and controlling the moving body so that an acceleration of the moving body in the current posture is smaller than or equal to the second allowable acceleration when the difference between the first allowable acceleration and the second allowable acceleration is smaller than the predetermined threshold value.

8. The method of claim 6, wherein a first direction and a second direction are parallel to the front-rear direction and opposite to each other, and
wherein, when the moving body is accelerated in the first direction, and an area in contact with the ground on a wheel, among the plurality of wheels, disposed in the body part in the second direction is referred to as a ground area,
in determining the first allowable acceleration and the second allowable acceleration, the first allowable acceleration and the second allowable acceleration are determined based on a separation distance between the ground area and the center of mass of the system.

9. The method of claim 8, wherein, in determining the first allowable acceleration and the second allowable acceleration,
when a ground contacting area of the moving body in the reference posture is referred to as a first ground area, the system including the moving body and the loaded object in the reference posture is referred to as a first system, a separation distance between the first ground area and a center of mass of the first system in a horizontal direction is referred to as a horizontal separation distance of the first system, and a separation distance between the first ground area and the center of mass of the first system in a vertical direction is referred to as a vertical separation distance of the first system,
the first allowable acceleration is calculated by dividing a product of the horizontal separation distance of the first system and a gravitational acceleration by the vertical separation distance of the first system, and
wherein, when a ground contacting area of the moving body in the current posture is referred to as a second ground area, the system including the moving body and the loaded object in the current posture is referred to as a second system, a separation distance between the second ground area and a center of mass of the second system in the horizontal direction is referred to as a horizontal separation distance of the second system, and a separation distance between the second ground area and the center of mass of the second system in the vertical direction is referred to as a vertical separation distance of the second system,
the second allowable acceleration is calculated by dividing a product of the horizontal separation distance of the second system and the gravitational acceleration by the vertical separation distance of the second system.

10. The method of claim 6, wherein the first allowable acceleration corresponds to a first ratio of a maximum acceleration at which the system including the moving body and the loaded object in the reference posture is not turned over in the front-rear direction, and the first ratio is 100% or less, and
wherein the second allowable acceleration corresponds to a second ratio of a maximum acceleration at which the system including the moving body and the loaded object in the current posture is not turned over in the front-rear direction, and the second ratio is 100% or less.
